(19) United States
(12) Patent Application Publication
(10) Pub. No.: US 2005/0023785 A1
(43) Pub. Date: Feb. 3, 2005

(54) Walled holding plate of a tool cart

(76) Inventor: George Liu, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/628,337

(22) Filed: Jul. 29, 2003

(51) Int. Cl. B62B 3/00

(52) U.S. Cl. 280/79.3

(57) ABSTRACT

A walled holding plate of a tool cart includes a bottom portion having a rectangular gap on each corner thereof, wall portions projecting upright from the edges of the bottom portion, and extension plates projecting upright from respective edges of the rectangular gaps of the bottom portion; each extension plate has through holes formed thereon; every two adjacent ones of the extension plates are secured to each other at tail ends; the walled holding plate is connected to wheeled upright supporting rods by means of screwing fixing elements into the through holes of the extension plates and selected ones of holes formed along the supporting rods; the walled holding plate can be relocated to other heights by means of connecting the extension plates to other ones of the holes of the supporting rods after the fixing elements have been undone.

### BACKGROUND OF THE INVENTION

1. Field of the Invention

The present invention relates to a walled holding plate of a tool cart used for holding tools in a workplace, more particularly one, which is adaptable in respect of heights to suit various different situations.

2. Brief Description of the Prior Art

Referring to FIG. 6, a conventional tool cart 2 includes four upright supporting rods 21, several walled rectangular holding plates 22, drawers, and wheels 23 joined to lower ends of the supporting rods 21. The walled holding plates 22 are spaced apart, and supported in position by means of the supporting rods 21; the walled holding plates 22 can be directly secured to the supporting rods 21 at the corners thereof by means of welding or supported by horizontal rods (not shown), which are fixedly connected to the upright supporting rods 21 by means of welding. The drawers are supported by horizontal rods, which are fixedly connected to the upright supporting rods 21 also by means of welding.

The tool cart is found to have a disadvantage that the walled holding plates and the horizontal supporting rods for the drawers can't be adapted in respect of position to suit various different situations. Because workers and mechanics, in order to perform their work efficiently and smoothly, need to have their tools supported on a tool cart at a suitable height according to the nature of work that they are currently doing, the above tool cart is not ideal due to the inadaptability of the walled holding plates and the drawers. And, many tool cars of the kind, of which walled holding plates and drawers are arranged in different heights, have to be prepared to suit various different needs and situations in a factory, causing waste of money and space.

### SUMMARY OF THE INVENTION

It is a main object of the present invention to provide a tool cart with a walled holding plate adaptable in height to overcome the above disadvantages.

The walled holding plate includes a bottom portion having a rectangular gap on each corner thereof, wall portions projecting upright from the edges of the bottom portion, and extension plates projecting upright from edges of the rectangular gaps; each extension plate has through holes; the walled holding plate is connected to wheeled upright supporting rods by means of screwing fixing elements into the through holes of the extension plates and selected ones of connecting holes formed along the supporting rods; the walled holding plate can be relocated to other heights by means of connecting the extension plates to other ones of the connecting holes after the fixing elements have been undone.

### BRIEF DESCRIPTION OF THE DRAWINGS

The present invention will be better understood by referring to the accompanying drawings, wherein:

FIG. 1 is a top view of the walled holding plate of a tool cart of the present invention, in a stretched position,

FIG. 2 is a side view of the walled holding plate of a tool cart of the present invention,

FIG. 3 is a perspective view of the walled holding plate of a tool cart of the present invention,

FIG. 4 is an exploded perspective view of the tool cart with the walled holding plate of the present invention,

FIG. 5 is an exploded perspective view of the tool cart with the walled holding plate of the second embodiment, and

FIG. 6 is a perspective view of the conventional tool cart as described in the Background.

### DETAILED DESCRIPTION OF THE PREFERRED EMBODIMENTS

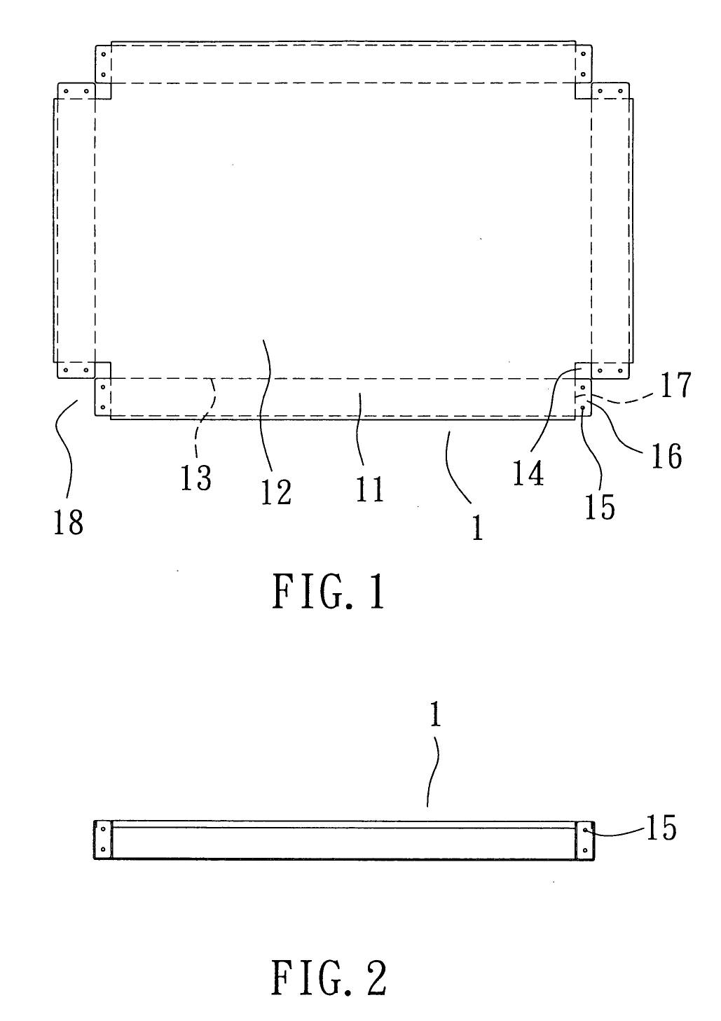

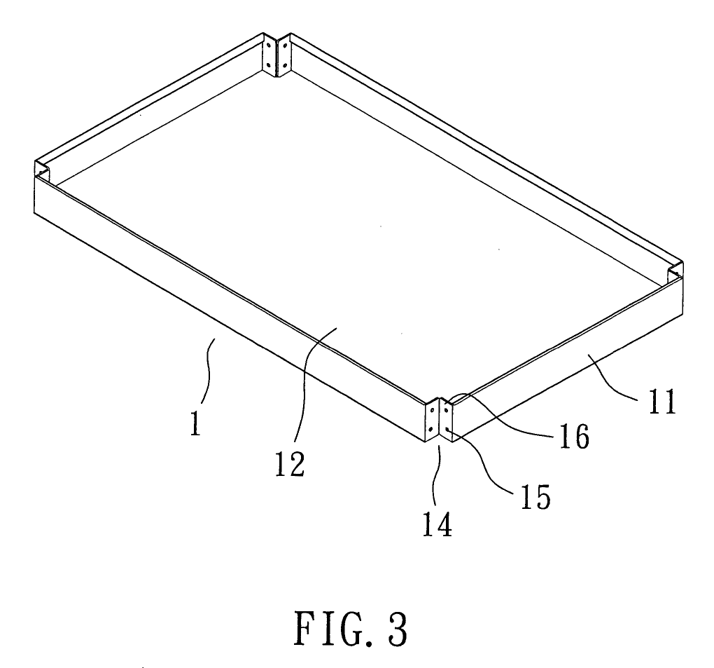

Referring to FIG. 1, which is a top view of a walled holding plate 1 of a tool cart in the present invention, in an unfolded position, the walled holding plate 1 has a bottom portion 12, and wall portions 11.

The bottom portion 12 is in the shape of a rectangle having rectangular gaps 14 formed on four corners thereof. The wall portions 11 extend from respective ones of four edges of the bottom portion 12. Extension plates 16 are provided, which extend from two ends of the wall portions 11 to be faced with corresponding edges of the rectangular gaps 14, and which are substantially as long as the corresponding edges of the rectangular gaps 14, such that the extension plates 16 and the bottom portion 12 together define four rectangular enclosures. And, a straight angle 18 is defined by every two adjacent ones of the extension plates 16. Each extension plate 16 has through holes 15 formed thereon. Folding lines 13 are formed between the bottom portion 12 and the wall portions 11. And, folding lines 17 are formed between the wall portions 1 and the extension plates 16.

To make the walled holding plate 1 ready for use, referring to FIG. 3, the walled holding plate 1 is folded along the folding lines 13 and 17 so that the wall portions 11 project upright from the edges of the bottom portion 12, and the extension plates 16 are perpendicular to the corresponding wall portions 11 with the outward sides of the extension plates 16 facing the rectangular gaps 14; every two adjacent ones of the extension plates 16 are secured to each other by means of welding. Thus, the rectangular gaps 14 are left outside the walled holding plate 1 after the walled holding plate 1 is made ready for use.

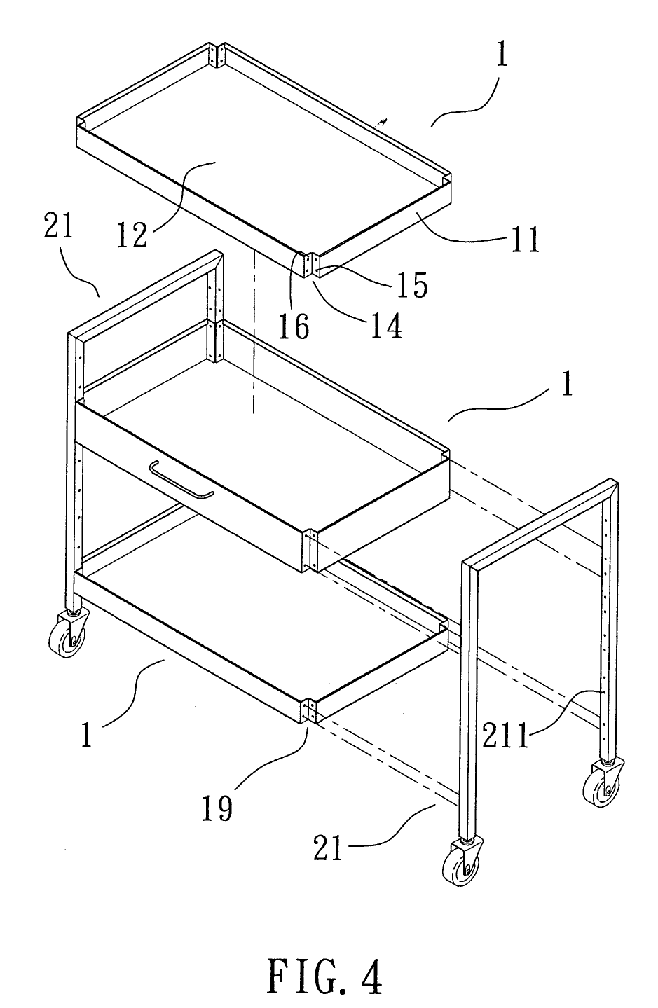

Referring to FIG. 4, upright supporting rods 21 of a tool cart have connecting holes 211 formed along them. To join the walled holding plate 1 to the upright supporting rods 21 of the tool cart, the rods 21 are fitted in the rectangular gaps 14 with selected ones of the connecting holes 211 thereof being faced with the through holes 15 of the holding plates 1, and fixing elements (not shown) are screwed into the connecting holes 211 and the through holes 15. Therefore, the walled holding plate 1 can be adapted in respect of height to suit various different needs.

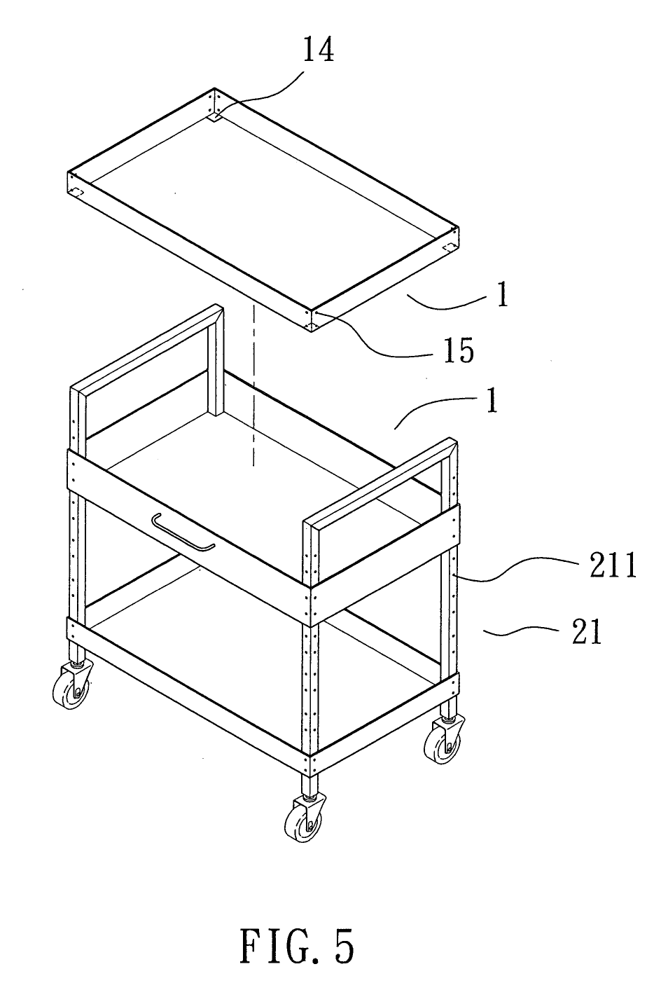

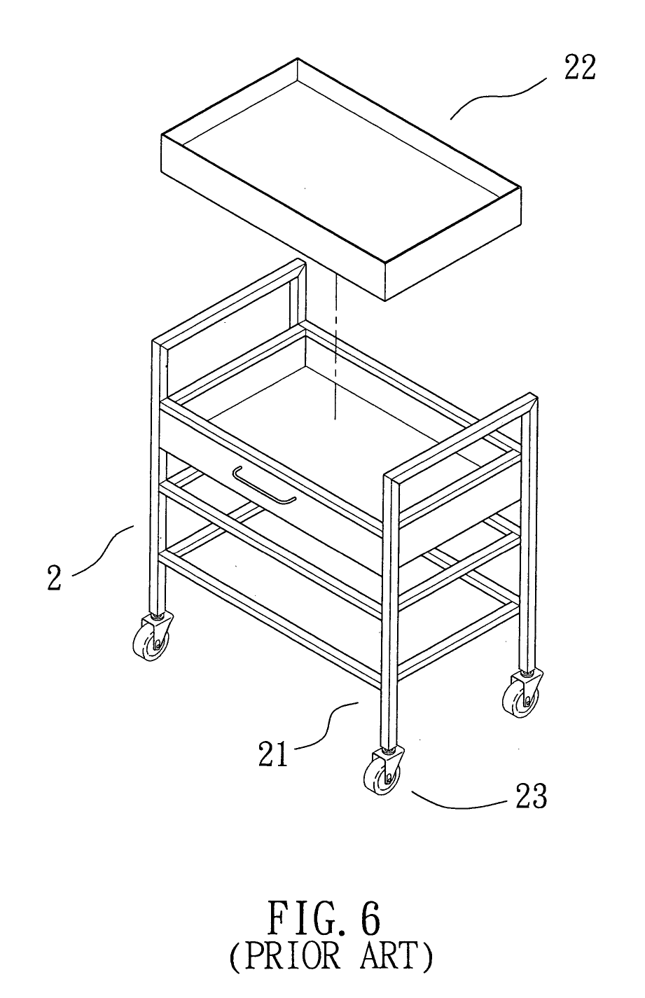

Referring to FIG. 5, according to a second embodiment of the present invention, the walled holding plate 1 is folded only along the folding lines 18 so that the wall portions 11 project upright from the edges of the bottom portion 12 with the inward sides of the extension plates 16 facing the rectangular gaps 14; every two adjacent ones of the extension plates 16 are secured to each other by means of welding. Thus, the rectangular gaps 14 are inside the walled holding plate 1 after the walled holding plate 1 is made ready for use. Referring to FIG. 5, upright supporting rods 21 of a tool cart have connecting holes 211 formed along outward sides thereof. To join the walled holding plate 1 to the upright supporting rods 21 of the tool cart, the rods 21 are passed through the rectangular gaps 14 with selected ones of the connecting holes 211 thereof being faced with the through holes 15 of the holding plates 1, and fixing elements (not shown) are screwed into the connecting holes 211 and the through holes 15.

From the above description, it can be easily understood that the walled holding plate of a tool cart in the present invention has advantages as followings:
1. Each corner of the walled holding plate 1 contacts, and is connected to two sides of a corresponding upright supporting rod 21 therefore the connection is relatively firm, and heavier tools can be put on the walled holding plate 1.
2. The users of the tool cart can relocate the walled holding plate to a height best suiting the nature of work that they are currently doing so that they can perform their work more efficiently and smoothly.

1. A walled holding plate of a tool cart, comprising, in an unfolded position,
a bottom portion having a rectangular gap formed on each corner thereof;
a plurality of wall portions extending from respective ones of edges of the bottom portion; first folding lines being formed between the bottom portion and the wall portions; and
extension plates extending from two ends of the wall portions to face corresponding edges of the rectangular gaps of the bottom portion; the extension plates being substantially as long as the corresponding edges of the rectangular gaps; each extension plate having through holes formed thereon; second folding lines being formed between the wall portions and the extension plates;
the walled holding plate being made ready for use by means of folding the walled holding plate along the first and the second folding lines such that the wall portions project upright from the edges of the bottom portion, and that the extension plates are perpendicular to respective wall portions with outward sides of the extension plates facing the rectangular gaps of the bottom portion; every two adjacent ones of the extension plates being secured to each other; the walled holding plate being connected to wheeled upright supporting rods by means of screwing fixing elements into the through holes of the extension plates and selected ones of holes formed along the supporting rods.

2. A walled holding plate of a tool cart, comprising, in an unfolded position,
a bottom portion having a rectangular gap formed on each corner thereof;
a plurality of wall portions extending from respective ones of edges of the bottom portion; first folding lines being formed between the bottom portion and the wall portions; and
extension plates extending from two ends of the wall portions to face corresponding edges of the rectangular gaps of the bottom portion; the extension plates being substantially as long as the corresponding edges of the rectangular gaps; each extension plate having through holes formed thereon;
the walled holding plate being made ready for use by means of folding the walled holding plate along the first folding lines such that the wall portions project upright from the edges of the bottom portion, and that the extension plates project upright from outer edges of the rectangular gaps of the bottom portion; every two adjacent ones of the extension plates being secured to each other; the walled holding plate being connected to wheeled upright supporting rods by means of screwing fixing elements into the through holes of the extension plates and selected ones of holes formed along the supporting rods.
